(19) United States
(12) Patent Application Publication
(10) Pub. No.: US 2025/0124077 A1
(43) Pub. Date: Apr. 17, 2025

(54) PROCESSING METHOD AND APPARATUS AND ELECTRONIC DEVICE

(71) Applicant: Lenovo (Beijing) Limited, Beijing (CN)

(72) Inventors: Lei YOU, Beijing (CN); Yonghua HU, Beijing (CN); Ruyun BAI, Beijing (CN); Yi MIAO, Beijing (CN)

(21) Appl. No.: 18/896,613

(22) Filed: Sep. 25, 2024

(30) Foreign Application Priority Data
Oct. 13, 2023 (CN) 202311330262.X

(51) Int. Cl. G06F 16/535; G06F 16/55; G06V 30/18; G06V 30/19; G06V 30/30

(52) U.S. Cl. CPC G06F 16/535; G06F 16/55; G06V 30/18; G06V 30/19093; G06V 30/1918; G06V 30/30

(57) ABSTRACT

A processing method includes obtaining character information, the character information being used to represent a search target, obtaining an image set, the image set including a plurality of images, and based on the character information, the image set, and an intelligent engine, obtaining an image search result including. Based on the character information and a first model in the intelligent engine, a first set is obtained. The first set includes a plurality of first images. Based on the first set, the image set, and a second model in the intelligent engine, a second set is obtained. The second set includes a plurality of second images, the second images is used as image search results, and the first model is different from the second model.

### CROSS-REFERENCE TO RELATED APPLICATION

The present disclosure claims priority to Chinese Patent Application No. 202311330262.X, filed on Oct. 13, 2023, the entire content of which is incorporated herein by reference.

### TECHNICAL FIELD

The present disclosure is related to the image processing technology field and, more particularly, to a processing method, a processing apparatus, and an electronic device.

### BACKGROUND

Currently, in the process of text-to-image search, a computer system compares the similarity between a text feature value of the input text and an image feature value of each image in the gallery to identify an image that matches the input text.

However, in such text-to-image searches, the search result is not accurate when the system only relies on similarity comparisons.

### SUMMARY

An aspect of the present disclosure provides a processing method. The processing method includes obtaining character information, the character information being used to represent a search target, obtaining an image set, the image set including a plurality of images, and based on the character information, the image set, and an intelligent engine, obtaining an image search result including. Based on the character information and a first model in the intelligent engine, a first set is obtained. The first set includes a plurality of first images. Based on the first set, the image set, and a second model in the intelligent engine, a second set is obtained. The second set includes a plurality of second images, the second images is used as image search results, and the first model is different from the second model.

An aspect of the present disclosure provides a processing apparatus, including a character acquisition unit, an image acquisition unit, and an image search unit. The character acquisition unit is configured to obtain character information, the character information being used to represent a search target. The image acquisition unit is configured to obtain an image set. The image set includes a plurality of images. The image search unit is configured to obtain an image search result based on the character information, the image set, and an intelligent engine. he image search unit is configured to based on the character information and a first model in the intelligent engine, obtain a first set, the first set including a plurality of first images, and based on the first set, the image set, and a second model in the intelligent engine, obtain a second set, the second set including a plurality of second images, the second image being an image search result, and the first model being different from the second model.

An aspect of the present disclosure provides an electronic device including one or more processors and one or more memories. The one or more memories store a computer program and data generated during running of the computer program that, when executed by the one or more processors, cause the one or more processors to obtain character information, the character information being used to represent a search target, obtain an image set, the image set including a plurality of images, and based on the character information, the image set, and an intelligent engine, obtain an image search result. Based on the character information and a first model in the intelligent engine, a first set is obtained. The first set includes a plurality of first images. Based on the first set, the image set, and a second model in the intelligent engine, a second set is obtained. The second set includes a plurality of second images. The second images are used as image search results. The first model is different from the second model.

### BRIEF DESCRIPTION OF THE DRAWINGS

FIG. 1 illustrates a schematic flowchart of a processing method according to some embodiments of the present disclosure.

FIG. 2 illustrates a schematic flowchart of filtering an image of an image set according to images of a first set in a processing method according to some embodiments of the present disclosure.

FIG. 3 illustrates a schematic structural diagram of a processing apparatus according to some embodiments of the present disclosure.

FIG. 4 illustrates a schematic structural diagram of an electronic device according to some embodiments of the present disclosure.

FIG. 5 illustrates a schematic architectural diagram of determining whether a text and an image match by extracting a text feature and an image feature through a Text Encoder and an Image Encoder in a CLIP model according to some embodiments of the present disclosure.

FIG. 6 illustrates a schematic diagram of searching an image from forming a text using characters to searching an image using images to obtain a search result in a cellphone scenario according to some embodiments of the present disclosure.

FIG. 7 illustrates a schematic diagram of searching for more zebra images from a zebra image in an album in a cell phone scenario according to some embodiments of the present disclosure.

FIG. 8 illustrates a schematic diagram of searching for more surfing images from a surfing image in an album in a cell phone scenario according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. Obviously, the described embodiments are merely some embodiments of the present disclosure, not all embodiments. Based on embodiments of the present disclosure, all other embodiments obtained by those skilled in the art without creative efforts are within the scope of the present disclosure.

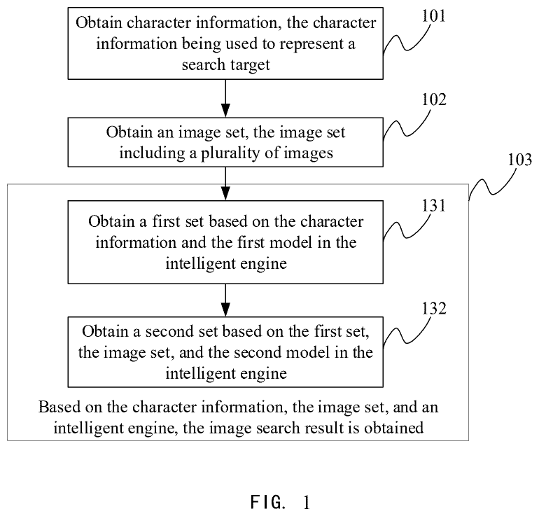

FIG. 1 illustrates a schematic flowchart of a processing method according to some embodiments of the present disclosure. The method can be suitable for an electronic device capable of performing image processing, e.g., a computer or a server. In the technical solution of embodiments of the present disclosure, the image can be searched to improve the accuracy of the search result.

In some embodiments, the method of embodiments of the present disclosure includes the following processes.

At 101, character information is obtained and is used to represent a search target.

The character information can include at least one string, e.g., a text including the string. The character information can be used to describe feature information of an image that the user needs to search for, e.g., a wolf, a goat, and surfing. The character information can include characters input through a keyboard or characters determined by converting an audio input.

In some embodiments, an input interface can be provided for the user. The user can perform a character input operation in the input interface. Based on this, in embodiments of the present disclosure, the character input operation of the user can be received, and the character input operation can be parsed to obtain character information of one or more characters.

At 102, an image set is obtained. The image set includes a plurality of images.

The image set can be a gallery including a plurality of candidate images. For example, the image set can be a set formed by images downloaded from the Internet, e.g., a cloud album, or the image set can be a set formed by images locally stored in the electronic device, e.g., a cellphone album.

At 103, based on the character information, the image set, and an intelligent engine, the image search result is obtained.

The intelligent engine can include a first model and a second model. The first model can be different from the second model. The first model can be configured to output an image matching an input string according to the input string. The second model can be configured to output an image matching an input image according to the input image. In some embodiments, the intelligent engine can be to a large language model (LLM), which is a computational model configured to generate languages or process natural language. The LLM can be trained with vast amount of text to obtain the abilities of generating the language or processing the natural language. The first model and the second model can belong to the LLM. The first model can be trained to perform text-to-image tasks, such as matching, generation, etc. The second model can be trained to perform image-to-image tasks, such as matching, generation, etc. In process 103, obtaining the image search result based on the character information, the image set, and the intelligent engine includes the following processes.

At 131, a first set is obtained based on the character information and the first model in the intelligent engine.

The first set can include a plurality of first images.

In some embodiments, the character information can be input into the first model. Thus, the first model can perform image search on the plurality of images included in the image set according to the character information to obtain a plurality of first images, i.e., the first set.

At 132, a second set is obtained based on the first set, the image set, and the second model in the intelligent engine.

The second set can include a plurality of second images. The second image can be used as the image search result.

In some embodiments, the plurality of first images of the first set can be input into the second mode to cause the second model to perform an image search on the plurality of images included in the image set according to the first images.

Based on the above, in the processing method of embodiments of the present disclosure, after obtaining the character information and the image set, the first model in the intelligent engine can first be configured to obtain the first set including the plurality of first images based on the character information. Then, the second model in the intelligent engine can be configured to obtain the second set including the plurality of second images based on the first images. Thus, after the image is searched according to the character information, the image can be searched again according to the searched image to improve the accuracy of the searched image.

Based on the above, the first model can be a model configured to match the text feature and the image feature.

In some embodiments, in process 131, the text feature of the character information can be extracted based on the first model, and the image feature corresponding to each image of the image set can be obtained. Then, based on the first model, the text feature of the character information can be matched with the text feature of each image of the image set to obtain the first set matching a first condition.

The first condition can include the image feature of the first image matching the text feature of the character information.

For example, based on the first model, the image of the image set with the image feature matching the text feature can be determined as the first image. The image feature matching the text feature can indicate that a cosine similarity between the text feature and the image feature is greater than or equal to a first similarity threshold, or the cosine similarity between the text feature and the image feature is front X after being sorted from large to small. The similarity threshold and X can be set as needed.

The image feature of each image of the image set can be obtained when each image is stored in the image set and can correspond to a corresponding image, or the image feature of each image in the image set can be the image feature of each image extracted by the first model when the first set is obtained.

In some embodiments, in the first model, the text feature of the character information can be extracted based on a Text Encoder of a pre-trained CLIP model (Contrastive Language-Image Pre-training) that compares a pair of text-image. The CLIP model can include the Text Encoder module and an Image Encoder module. The Text Encoder module can be configured to extract the text feature of the input text. The Image Encoder module can be configured to extract the image feature of the input image. When the CLIP model performs a comparison based on the text feature output by the Text Encoder module and the image feature output by the Image Encoder module, the CLIP model can output a result indicating whether the input text matches the input image. When each image of the image set is stored in the image set, the image feature of the image can be obtained by the Image Encoder module in the CLIP model. In some other embodiments, when the first set is obtained, while the text feature of the character information is extracted by the Text Encoder module, the image feature of each image in the image set can be obtained by the Image Encoder module.

In some other embodiments, in process 131, the text feature of the character information can be extracted based on the first model. Then, based on the first model, the image feature matching the text feature can be obtained. Then, based on the image feature matching the text feature, the first set meeting the first condition can be generated.

In some embodiments, image construction can be performed on the input image feature matching the text feature through the pre-trained text-to-image model to generate a plurality of first images, i.e., the first set. The text-to-image model can output a corresponding new image for the input image feature. The first condition can include that the image feature of the first image matches the text feature of the character information, i.e., the cosine similarity between the text feature and the image feature can be greater than or equal to the first similarity threshold.

That is, the first image obtained in embodiments of the present disclosure can be the image searched in the image set according to the text feature of the character information, or an image generated by the text-to-image model according to the text feature of the character information.

The second model can be a model, which is configured to match the image feature and the feature.

In some embodiments, the second model can be configured to perform an image search on the image set according to the image feature of the first image to obtain a second image meeting a second condition to obtain a second set. The second condition can include the image feature of the second image matching the text feature of the character information. That is, the cosine similarity between the image feature of the second image and the text feature of the character information is greater than or equal to a second similarity threshold. The second similarity threshold can be greater than the first similarity threshold. Thus, the obtained second set can have a higher degree of matching with the character information, which is higher than the degree of matching between the first set and the character information. Therefore, in embodiments of the present disclosure, an initial image search can be performed on the image set first through the text feature of the character information to obtain the first set having a corresponding matching with the character information. Then, a deep image search can be performed on the image set through the image feature of the first image based on the first set to obtain the second set having a higher degree of matching with the character information. Thus, the obtained second image can match the character information better, the accuracy of the image search can be improved, and the user image search requirement can be satisfied.

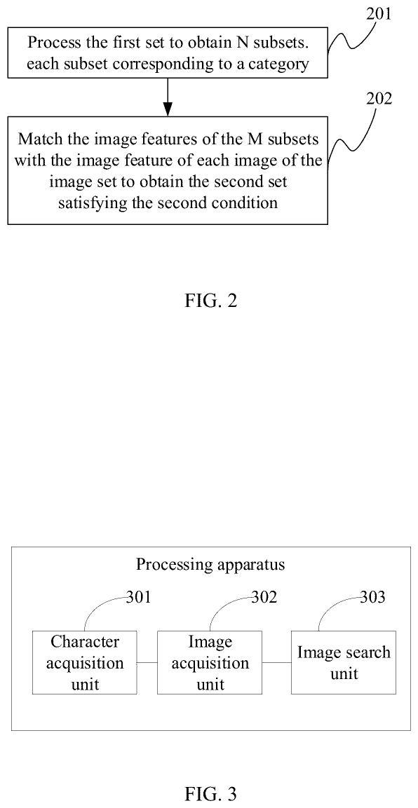

As shown in FIG. 2, based on the above solution, in process 132, obtaining the second set based on the first set, the image set, and the second model of the intelligent engine includes the following processes.

At 201, the first set is processed to obtain N subsets. Each subset corresponds to a category.

In some embodiments, the image similarity between any two first images in the first set can be obtained. Then, based on the image similarity, the first images can be categorized to obtain the N subsets. Within the same subset, the image similarity between any two images can be greater than or equal to the first threshold, and the image similarity between images in different subsets can be less than the first threshold. Then, the N subsets can be subsets obtained after all the first images in the first set are processed.

The first threshold can be preset as needed, e.g., 0.75. The image similarity between the two first images can be the cosine similarity between image features of two first images. For example, for each first image in the first set, the image similarity between the first image and all other first images can be obtained. Then, the first image with an image similarity greater than or equal to the first threshold can be divided into a subset. Each image in the first set can be divided into a corresponding subset. The first set can be divided into the N subsets.

In some other embodiments, according to the sequence of the first images in the first set, for each first image, another first image can be selected sequentially to obtain the image similarity between the two first images. The first image with the image similarity greater than or equal to the first threshold can be divided into one subset. Then, a next first image can be selected until the N subsets are obtained. The number of the first images of each subset can exceed a preset number threshold. Sometimes, a first image of the first set may not be divided into a certain subset. The N subsets can be the subsets sequentially obtained after some images of the first set are processed. M and N can be integers greater than or equal to 1. M can be smaller than or equal to N. M subsets can be at least some subsets of the N subsets. Correspondingly, the M subsets can be subsets sequentially obtained after some first images of the first set are processed.

For example, for the first one of the first images, the image similarity between the second one of the first images and the first one of the first images can be obtained. If the image similarity is greater than or equal to the first threshold, the first one of the first images and the second one of the first images can be grouped into one subset. Then, the image similarity between the third one of the first images and the first one of the first images can be obtained. If the image similarity is smaller than the first threshold, the third one of the first images may not grouped into the subset with the first one of the first images. Then, the image similarity between the fourth one of the first images and the first one of the first images can be obtained. If the image similarity is smaller than the first threshold, the image similarity between the fourth one of the first images and the third one of the first images can be obtained. If the image similarity is greater than or equal to the first threshold, the third one of the first images and the fourth one of the first images can be grouped into one subset. Then, the image similarity between the fifth one of the first images and the first one of the first images can be obtained. If the image similarity is greater than or equal to the first threshold, the fifth one of the first images and the first one of the first images can be grouped into the subset. As so on, when the N subsets are obtained, the image similarity may no longer be obtained for the remaining first images. Thus, for the N subsets, each subset can correspond to a category. The category can indicate that the images in the category can be similar.

At 202, the image features of the M subsets are matched with the image feature of each image of the image set to obtain the second set satisfying the second condition.

M and N can be integers greater than or equal to 1, and M can be less than or equal to N.

In some embodiments, the N subsets can be obtained after all the first images in the first set are processed. Based on this, the M subsets can be at least some subsets of the N subsets. Correspondingly, the M subsets can be the subsets obtained after all the first images of the first set are processed.

In some embodiments, obtaining the M subsets can include the following processes.

First, an initial similarity between each image of a subset and the character information can be obtained. Then, for each subset, the similarities can be averaged according to the image number of the subset to obtain the average similarity of the subset corresponding to the character information. Then, the N subsets can be sorted according to the average similarities from large to small, and the first M subsets can be determined as the M subsets.

For example, in some embodiments, the cosine similarity between the image feature of each image in each subset and the text feature of the character information can be obtained. By using the subset as a unit, the cosine similarities of all the images in the subset can be summed, and the sum of the cosine similarities can be averaged over the number of all the images in the subset to obtain the average similarity corresponding to the subset. Then, the N subsets can be sorted according to the corresponding average similarities from large to small. Then first M subsets can be selected.

In some other embodiments, the N subsets can be subsets obtained after some first images in the first set are processed. Based on this, the M subsets can be at least some subsets of the N subsets. Correspondingly, the M subsets can be the subsets sequentially obtained after some first images in the first set are processed.

In some embodiments, obtaining the M subsets can include the following processes.

According to the sequence of the first images in the first set, for each first image, another first image can be selected in sequence. The image similarity between the two first images can be obtained. The first image with the image similarity greater than or equal to the first threshold can be grouped into one subset. Then, a next first image can be selected until the M subsets are obtained.

Based on the above, in process 202, when the image features of the M subsets are matched with the image feature of each image in the image set, target images satisfying the selection condition with the M subsets can be selected from the image set or the first set according to the image number in the first set to obtain the second set satisfying the second condition.

When the image number of the first set is greater than or equal to the target threshold, first target images can be selected from the first set according to the image features of the M subsets to obtain the second set satisfying the second condition.

The first target images and the M subsets can satisfy a first selection condition. The first selection condition can include the image feature of the third image in the M subsets matching the image feature of the first target image, and the first target image being a first image in the first set different from the images in the M subsets.

For example, in some embodiments, if the image number in the first set is relatively large, in process 202, similarity matching can be performed on the image feature of each first image in the first set except the M subsets and the image feature of any image in the M subsets. If the image similarity between the image feature of the first image (i.e., the first target image) in the first set except for the M subsets and the image feature of an image (i.e., the third image) in the M subsets is greater than or equal to the second threshold, e.g., 0.9, the first image of the first set can be selected, i.e., the second image satisfying the second condition.

An image in the M subsets can also be used as a second image. The second image selected from the first set and the image in the M subsets can form the second set.

When the image number in the first set is smaller than the target threshold, according to the image feature of the M subsets, the second target image can be selected from the image set to obtain the second set satisfying the second condition.

The second target image and the M subsets can satisfy the second selection condition. The second selection condition can include the image feature of the fourth image in the M subsets matching the image feature of the second target image, and the second target image being an image in the image set different from the images of the M subsets.

For example, in some embodiments, if the image number in the first set is relatively small, in process 202, similarity matching can be performed on the image feature of each first image in the first set except the M subsets and the image feature of any image in the M subsets. If the image similarity between the image feature of the image (i.e., the second target image) in the first set except for the M subsets and the image feature of an image (i.e., the fourth image) in the M subsets is greater than or equal to the second threshold, e.g., 0.9, the image of the image set can be selected, i.e., the second image satisfying the second condition.

An image in the M subsets can also be used as a second image. The second image selected from the image set and the image in the M subsets can form the second set.

In embodiments of the present disclosure, based on the first model, the text feature of the character information can be extracted. Then, based on the first model, the text feature can be matched with the image feature of each image in the image set to obtain a first set al satisfying the first condition. Meanwhile, in embodiments of the present disclosure, the image feature matching the text feature of the character information can be obtained by the first model. Then, based on the image feature matching the text feature, the first set a2 satisfying the first condition can be generated. Then, the images in first set a2 can be added to first set a1. Subsequently, the second model can be configured to process first set a1 to obtain N1 subsets. Each subset can correspond to a category. M subsets can be selected from the N1 subsets. Then, the image features of the M1 subsets can be matched with the image feature of each image in the image set to obtain the second set satisfying the second condition.

In some other embodiments, the first model can first extract the text feature of the character information. Then, the first model can perform matching on the text feature and the image feature of each image of the image set to obtain first set a2 satisfying the first condition. Then, the second model can be configured to process first set a2 to obtain N2 subsets. Each subset can correspond to a category. M2 subsets can be selected from the N2 subsets. Meanwhile, in embodiments of the present disclosure, the first model can be configured to the image feature matching the text feature of the character information. Then, based on the image feature matching the text feature, first set a3 satisfying the first condition can be generated. For first set a3, the second model can be configured to process first set a3 to obtain N3 subsets. Each subset can correspond to a category. M3 subsets can be selected from the N3 subsets. The M3 subsets can be grouped with the M2 subsets selected above. Then, the image features of the M3+M2 subsets can be matched with the image feature of each image in the image set to obtain the second set satisfying the second condition.

In some embodiments, the first model can be configured to first extract the text feature of the character information. Then, based on the first model, the text features can be matched with the image feature of each image in the image set to obtain first set a4 satisfying the first condition. Subsequently, the second model can be configured to process first set a4 to obtain N4 subsets. Each subset can correspond to a category. M4 subsets can be selected from the N4 subsets. Then, the image features of the M4 subsets can be matched with the image feature of each image in the image set to obtain the second set satisfying the second condition.

In some embodiments, the first model can be configured to first extract the text feature of the character information, then obtain the image feature that matches the text feature of the character information, and generate first set a5 satisfying the first condition based on the image feature satisfying the text feature. Then, the second model can be configured to process first set a5 to obtain N5 subsets. Each subset can correspond to a category. M5 subsets can be selected from the N5 subsets. Then, the image features of the M5 subsets can be matched with the image feature of each image in the image set to obtain the second set satisfying the second condition.

FIG. 3 illustrates a schematic structural diagram of a processing apparatus according to some embodiments of the present disclosure. The apparatus can be arranged at the electronic device capable of image processing, e.g., a computer or server. The technical solution of embodiments of the present disclosure can be mainly used to realize image search to improve the accuracy of the search result.

In some embodiments, the apparatus includes a character acquisition unit 301, an image acquisition unit 302, and an image search unit 303.

The character acquisition unit 301 can be configured to obtain character information. The character information can be used to represent a search target.

The image acquisition unit 302 can be configured to obtain an image set. The image set can include a plurality of images.

The image search unit 303 can be configured to obtain an image search result based on the character information, the image set, and the intelligent engine.

In some embodiments, the image search unit can be configured to obtain the first set based on the character information and the first model in the intelligent engine. The first set can include a plurality of first images. Based on the first set, the image set, and the second model in the intelligent engine, the image search unit can be further configured to obtain the second set. The second set can include a plurality of second images. The second image can be used as the image search result. The first model can be different from the second model.

Based on the above, in the processing apparatus of embodiments of the present disclosure, after the character information and the image set are obtained, the first model of the intelligent engine can be first configured to obtain the first set including the plurality of first images based on the character information. Then, the second model of the intelligent engine can be configured to obtain the second set including the plurality of second images based on the first image. Thus, after the image search is performed according to the character information, the image search can be performed again according to the searched image to improve the accuracy of the searched image.

In some embodiments, the first model can be a model configured to match the text feature with the image feature. The second model can be a model configured to match the image feature with the image feature. The degree of matching of the second set and the character information can be higher than the degree of matching of the first set and the character information.

In some embodiments, when the first set is obtained based on the character information and the first model in the intelligent engine, the image search unit 303 can be configured to extract the text feature of the character information based on the first model, and match the text feature with the image feature of each image of the image set based on the first model to obtain the first set satisfying the first condition.

In some embodiments, when the first set is obtained based on the character information and the first model in the intelligent engine, the image search unit 303 can be configured to extract the text feature of the character information based on the first model, obtain the image feature matching the text feature based on the first model, and generate the first set matching the first condition based on the image feature matching the text feature.

In some embodiments, when the second set is obtained based on the first set, the image set, and the second model in the intelligent engine, the image search unit 303 can be configured to process the first set to obtain N subsets, each subset corresponding to a category, matching the image feature of the M subsets with the image feature of each image in the image set to obtain the second set satisfying the second condition. M and N can be positive integers greater than or equal to 1. M can be smaller than or equal to N. The M subsets can be subsets obtained sequentially after some first images in the first set are processed, or the M subsets can be subsets obtained after all the first images in the first set are processed.

In some embodiments, when the N subsets are obtained by processing the first set, the image search unit 303 can be configured to obtain the image similarity between any two first images in the first set, group the first images according to the image similarity to obtain the N subsets. The image similarity between any two images in the same subset can be greater than or equal to the first threshold.

In some embodiments, the image search unit 303 can obtain the M subsets in the following method. An initial similarity between each image of each subset and the character information can be obtained. For each subset, the initial similarity can be averaged according to the image number in the subset to obtain the average similarity of the subset corresponding to the character information. The N subsets can be sorted according to the average similarity from large to small. The first M subsets can be determined as the M subsets.

In some embodiments when the image feature of the M subsets are matched with the image feature of each image in the image set to obtain the second set satisfying the second condition, the image search unit 303 can be configured to, when the image number in the first set is greater than or equal to the target threshold, select the first target image in the first set according to the image features of the M subsets to obtain the second set satisfying the second condition. The first target image and the M subsets can satisfy the first selection condition. The first selection condition can include the image feature of the third image in the M subsets matching the image feature of the first target image, and the first target image being a first image in the first set different from the images in the M subsets. When the image number in the first set is smaller than the target threshold, the second target image can be selected in the image set according to the image features of the M subsets to obtain the second set satisfying the second condition. The second target image and the M subsets can satisfy the second selection condition. The second selection condition can include the image feature of the fourth image in the M subsets matching the image feature of the second target image, and the second target image being an image in the image set different from the images in the M subsets.

For detailed implementation of units in the present disclosure, reference can be made to the above description, which is not repeated here.

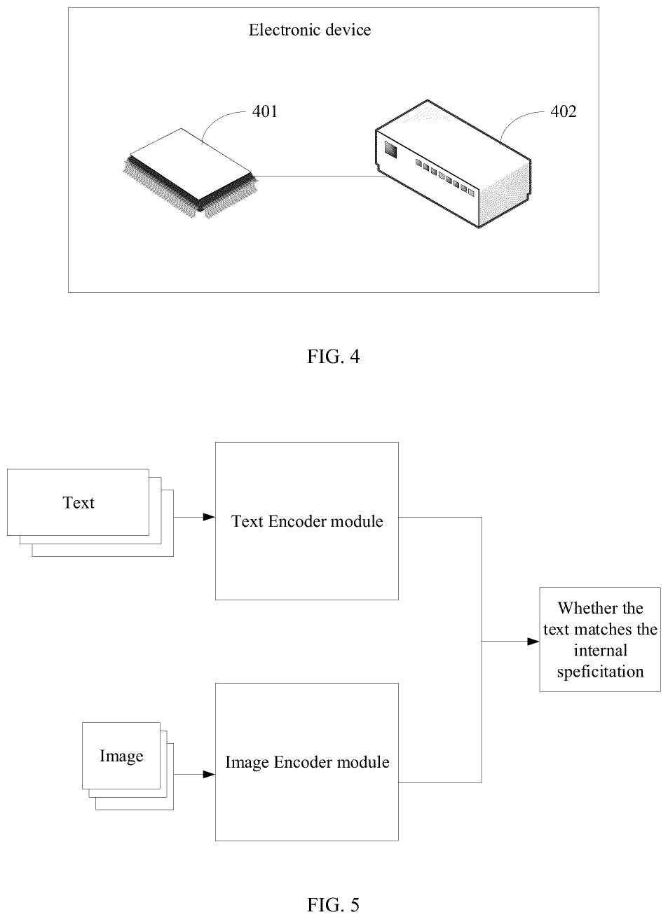

FIG. 4 illustrates a schematic structural diagram of an electronic device according to some embodiments of the present disclosure. The electronic device includes a memory 401 and a processor 402.

The memory 401 can be used to store a computer program and data generated when the computer program is running.

The processor 402 can be configured to execute the computer program to obtain the character information, the character information being used to represent a search result, obtain an image set, the image set including a plurality of images, and obtain the image search result based on the character information, the image set, and the intelligent engine. Obtaining the image search result based on the character information, image set, and the intelligent engine can include obtaining the first set based on the character information and the first model in the intelligent engine, the first set including the plurality of first images, obtain a second set based on the first set, the image set, and the intelligent engine. The second set can include a plurality of second images. The second image can be used as an image search result. The first model can be different from the second model.

Based on the above, in the electronic device of embodiments of the present disclosure, after the character information and the image set are obtained, the first model of the intelligent engine can be configured to first obtain the first set including the plurality of first images based on the character information. Then, the second model of the intelligent engine can be configured to obtain the second set including the plurality of second images based on the first image. Thus, after the image search is performed according to the character information, and the image search can be performed again according to the searched image to improve the accuracy of the searched image.

For implementation of the processor, reference can be made to the above relevant content, which is not repeated here.

For example, the electronic device is a cellphone. The cellphone can have the text-to-image search function (characters forming a text for image search). The user can input text. The image can be searched according to the input text, and a corresponding image can be output for the user.

Currently, during the search process from text to image, the similarity between the image and the input text can be determined by calculating the cosine similarity between the text feature value and the image feature value of each image in the image set. During this process, the range of the calculated cosine similarity may not be very distinct, and there is no stable threshold for determining whether the images match. Thus, the content that does not match can be difficult to be filtered out during the search process, which leads to the inaccuracy of the searched image.

Based on this, the text-to-image search function of the cellphone can be improved, which is described below.

First, the CLIP model can primarily includes a Text Encoder module and an Image Encoder module. As shown in FIG. 5, the text feature and the image feature can be extracted. An image retrieval task can be realized based on the CLIP model.

In addition, since the cosine similarity between the images can be more accurate than the cosine similarity between the text and the image, the image that matches better or does not match can be selected according to the cosine similarity between the image features.

Based on this, in the present disclosure, first X images can be first selected according to the cosine similarity between the text feature and the image feature. Then, the first X images can be grouped to find the category of the top Y. Subsequently, the cosine similarity between the image feature in the Top Y category and the remaining image feature in the image set can be calculated. The image greater than a certain threshold can be used as a final result.

Through the solution, the returned result of the text-to-image search can be filtered again through the image-to-image search, which avoids that only a fixed number of results can be returned to the user each time and the user experience for the text-to-image search can be optimized.

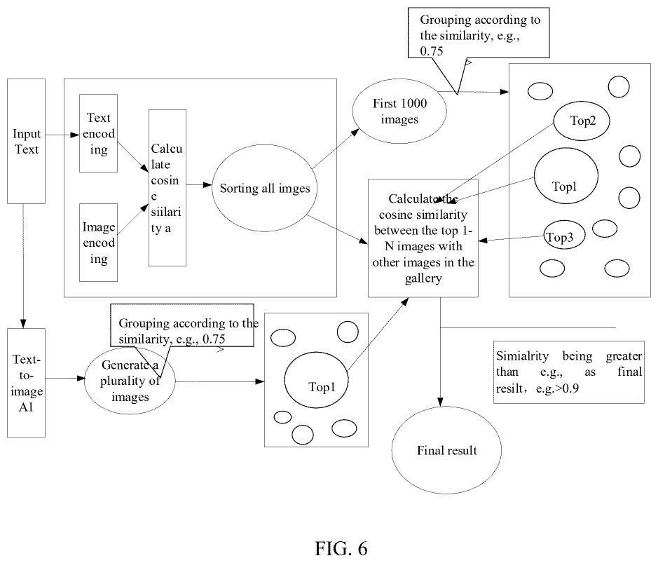

As shown in FIG. 6, the technical solution of the present disclosure is described in detail below.

First, the user can input the text from the cellphone input interface, the text feature, i.e., text encoding, can be obtained by the Text Encoder module in the CLIP model. In addition, the image feature, i.e., image encoding, can be pre-obtained by the Image Encoder module for each image in the gallery. The cosine similarities between all to-be-searched image features in the gallery and the text feature can be calculated and can be sorted from high to low. The first 1000 images can be selected.

Then, after the first 1000 images are selected, the images can be categorized. In some embodiments, two images can be obtained in sequence from the 1000 images. The cosine similarity between the image features of the two images can be compared to the threshold, e.g., 0.75. The images having the cosine similarity between the image features greater than 0.75 can be divided into one category, and so on, until N categories of images with relatively high cosine similarities are obtained, i.e., the N subsets, e.g., Top 1-3 categories of images.

Finally, the cosine similarities between the image features of the top N categories of images and the image features of other images in the gallery can be calculated. Images of the other images in the gallery with the cosine similarities greater than a certain threshold, e.g., 0.9, can be used as all results of this search.

The technical solution of the present disclosure can also be applied to another scenario.

For example, in the text-to-image search scenario, a text-to-image AI model can be first used to generate corresponding images according to the text. Then, the images can be used to search for the corresponding images.

For another example, when a new image is generated based on the existing images, some generation effects may not be good. After a plurality of photos are generated at once, the generated images can be compared with the existing template image for the similarity based on the technical solution of the present disclosure, some images with bad generation effects can be automatically filtered out.

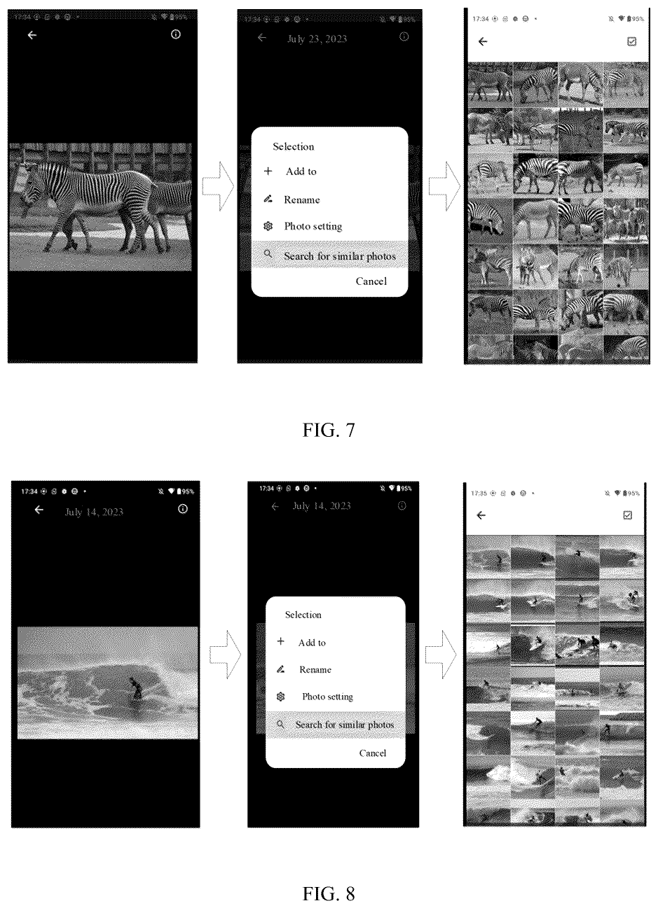

For another example, an image-to-image search function based on semantics can be added to the album based on the technical solution of the present disclosure. As shown in FIG. 7, a zebra image is searched in the album. A plurality of similar zebra images on the right are obtained through the image-to-image search function in the technical solution of the present disclosure. As shown in FIG. 8, a surfing image is searched in the album. A plurality of similar surfing images on the right are obtained through the image-to-image search function in the technical solution of the present disclosure.

Embodiments of the present disclosure are described in a progressive manner. Each embodiment focuses on differences from other embodiments. The similar parts among the embodiments can be referred to each other. Since apparatus embodiments correspond to the method embodiments. Thus, the description can be simple, and the relevant part can be referred to the description of the method part.

Those skilled in the art can further understand that units and algorithm steps of embodiments of the present disclosure can be implemented by electronic hardware, computer software, or a combination thereof. To describe the interchangeability of the hardware and the software, the components and steps of embodiments of the present disclosure are generally according to the functions. Whether the functions are implemented by the hardware or the software can rely on the specific application and design constraint based on the technical solution. Those skilled in the art can realize the described function in different methods for each specific application, however, this implementation cannot considered as exceeding the range of the present application.

In connection with embodiments of the present disclosure, the described method or the steps of the algorithm can be directly implemented by hardware, a software module executed by the processor, or a combination thereof. The software module can be arranged in random access memory (RAM), memory, read-only memory (ROM), electrically programmable ROM (EPROM), electrically erasable programmable ROM (EEPROM), registers, hard disks, removable disks, CD-ROMs, or any other form of storage medium known in the art.

The above description of embodiments of the present disclosure can enable those skilled in the art to make or use the present disclosure. Various modifications to the embodiments of the present disclosure can be obvious for those skilled in the art. The general principle defined in the specification can be implemented in other embodiments without departing from the spirit or scope of the present disclosure. Thus, the present disclosure is not limited to embodiments shown in the specification but should conform to the widest scope consistent with the principle and novel features of the present disclosure.

What is claimed is:

1. A processing method comprising:
obtaining character information, the character information being used to represent a search target;
obtaining an image set, the image set including a plurality of images; and
based on the character information, the image set, and an intelligent engine, obtaining an image search result including:
based on the character information and a first model in the intelligent engine, obtaining a first set, the first set including a plurality of first images; and
based on the first set, the image set, and a second model in the intelligent engine, obtaining a second set, the second set including a plurality of second images, the second images being used as image search results, and the first model being different from the second model.

2. The method according to claim 1, wherein:
the first model is configured to match a text feature with an image feature;
the second model is configured to match an image feature with an image feature; and
a degree of matching between the second set and the character information is higher than a degree of matching between the first set and the character information.

3. The method according to claim 2, wherein, based on the character information and the first model in the intelligent engine, obtaining the first set includes:
extracting the text features of the character information based on the first model; and
matching the text feature with an image feature of each image in the image set based on the first model to obtain the first set satisfying a first condition.

4. The method according to claim 2, wherein, based on the character information and the first model in the intelligent engine, obtaining the first set includes:
extracting the text feature of the character information based on the first model;
obtaining an image feature matching the text feature based on the first model; and
generating the first set satisfying the first condition based on the image feature matching the text feature.

5. The method according to claim 4, wherein, based on the first set, the image set, and the second model in the intelligent engine, obtaining the second set includes:
processing the first set to obtain N subsets, each subset corresponding to a category;
matching image features of M subsets with an image feature of each image in the image set to obtain the second set satisfying a second condition;
wherein:
M and N are positive integers greater than or equal to 1;
M is less than or equal to N; and
the M subsets are obtained sequentially after processing some first images in the first set, or the M subsets are obtained by processing all first images in the first set.

6. The method according to claim 5, wherein processing the first set to obtain the N subsets includes:
obtaining an image similarity between any two first images in the first set;
grouping the first images according to the image similarity to obtain the N subsets; and
an image similarity between any two images in a same subset is greater than or equal to a first threshold.

7. The method according to claim 5, wherein obtaining the M subsets includes:
obtaining the initial similarity between each image in each subset and the character information;
for each subset, averaging an initial similarity based on an image number in the subset to obtain the average similarity of the subset corresponding to the character information; and
sorting the average similarity of the N subsets from largest to smallest and determining top M subsets as the M subsets.

8. The method according to claim 5, wherein matching image features of the M subsets with the image feature of each image in the image set to obtain the second set satisfying the second condition includes:
when the image number in the first set is greater than or equal to a target threshold, filtering a first target image in the first set according to the image features of the M subsets to obtain the second set satisfying the second condition;
wherein:
the first target image and the M subsets satisfies a first selection condition, and the first selection condition includes an image feature of a third image in the M subsets matching an image feature of the first target image, and the first target image being a first image in the first set different from images in the M subsets; and
when the number of images in the first set is less than the target threshold, filtering a second target image in the image set according to the image features of the M subsets to obtain the second set satisfying the second condition;
wherein:
the second target image and the M subsets satisfies a second selection condition, and the second selection condition includes an image feature of a fourth image in the M subsets matching an image feature of the second target image, and the second target image being an image in the image set different from images in the M subsets.

9. A non-transitory computer-readable storage medium storing a computer program that, when executed by one or more processors, causes the one or more processors to:
obtain character information, the character information being used to represent a search target;
obtain an image set, the image set including a plurality of images; and
obtain an image search result based on the character information, the image set, and an intelligent engine including:
based on the character information and a first model in the intelligent engine, obtaining a first set, the first set including a plurality of first images, and
based on the first set, the image set, and a second model in the intelligent engine, obtaining a second set, the second set including a plurality of second images, the second image being an image search result, and the first model being different from the second model.

10. The storage medium according to claim 9, wherein the one or more processors are further configured to:
match a text feature with an image feature; and
match an image feature with an image feature;
wherein a degree of matching between the second set and the character information is higher than a degree of matching between the first set and the character information.

11. The storage medium according to claim 10, wherein, based on the character information and the first model in the intelligent engine, the one or more processors are further configured to:
extract the text features of the character information based on the first model; and
match the text feature with an image feature of each image in the image set based on the first model to obtain the first set satisfying a first condition.

12. The storage medium according to claim 10, wherein, based on the character information and the first model in the intelligent engine, the one or more processors are further configured to:
extract the text feature of the character information based on the first model;
obtain an image feature matching the text feature based on the first model; and
generate the first set satisfying the first condition based on the image feature matching the text feature.

13. An electronic device comprising:
one or more processors; and
one or more memories storing a computer program and data generated during running of the computer program that, when executed by the one or more processors, cause the one or more processors to:
obtain character information, the character information being used to represent a search target;
obtain an image set, the image set including a plurality of images; and
based on the character information, the image set, and an intelligent engine, obtain an image search result including:
based on the character information and a first model in the intelligent engine, obtaining a first set, the first set including a plurality of first images; and
based on the first set, the image set, and a second model in the intelligent engine, obtaining a second set, the second set including a plurality of second images, the second images being used as image search results, and the first model being different from the second model.

14. The device according to claim 13, wherein:
the first model is configured to match a text feature with an image feature;
the second model is configured to match an image feature with an image feature; and
a degree of matching between the second set and the character information is higher than a degree of matching between the first set and the character information.

15. The device according to claim 14, wherein the one or more processors are further configured to:
extract the text features of the character information based on the first model; and
match the text feature with an image feature of each image in the image set based on the first model to obtain the first set satisfying a first condition.

16. The device according to claim 14, wherein the one or more processors are further configured to:
extract the text feature of the character information based on the first model;
obtain an image feature matching the text feature based on the first model; and
generate the first set satisfying the first condition based on the image feature matching the text feature.

17. The device according to claim 16, wherein the one or more processors are further configured to:
process the first set to obtain N subsets, each subset corresponding to a category; and
match image features of M subsets with an image feature of each image in the image set to obtain the second set satisfying a second condition;
wherein:
M and N are positive integers greater than or equal to 1;
M is less than or equal to N; and
the M subsets are obtained sequentially after processing some first images in the first set, or the M subsets are obtained by processing all first images in the first set.

18. The device according to claim 17, wherein the one or more processors are further configured to:
obtain an image similarity between any two first images in the first set; and
group the first images according to the image similarity to obtain the N subsets;
wherein an image similarity between any two images in a same subset is greater than or equal to a first threshold.

19. The device according to claim 17, wherein the one or more processors are further configured to:
obtain the initial similarity between each image in each subset and the character information;
for each subset, average an initial similarity based on an image number in the subset to obtain the average similarity of the subset corresponding to the character information; and
sort the average similarity of the N subsets from largest to smallest and determining top M subsets as the M subsets.

20. The device according to claim 17, wherein the one or more processors are further configured to:
when the image number in the first set is greater than or equal to a target threshold, filter a first target image in the first set according to the image features of the M subsets to obtain the second set satisfying the second condition;
wherein:
the first target image and the M subsets satisfies a first selection condition, and the first selection condition includes an image feature of a third image in the M subsets matching an image feature of the first target image, and the first target image being a first image in the first set different from images in the M subsets; and
when the number of images in the first set is less than the target threshold, filter a second target image in the image set according to the image features of the M subsets to obtain the second set satisfying the second condition;
wherein:
the second target image and the M subsets satisfies a second selection condition, and the second selection condition includes an image feature of a fourth image in the M subsets matching an image feature of the second target image, and the second target image being an image in the image set different from images in the M subsets.
